(19) United States
(12) Patent Application Publication
(10) Pub. No.: US 2011/0307741 A1
(43) Pub. Date: Dec. 15, 2011

(54) Non-intrusive debugging framework for parallel software based on super multi-core framework

(75) Inventors: Tien-Fu Chen, Chia-Yi (TW); Che-Neng Wen, Chia-Yi (TW); Shu-Hsuan Chou, Chia-Yi (TW); Yen-Lan Hsu, Chia-Yi (TW)

(73) Assignee: NATIONAL CHUNG CHENG UNIVERSITY, CHIA-YI (TW)

(21) Appl. No.: 12/923,913

(22) Filed: Oct. 14, 2010

(30) Foreign Application Priority Data
Jun. 15, 2010 (TW) 99119529

(51) Int. Cl. G06F 11/36

(52) U.S. Cl. 714/38.1; 714/E11.208

(57) ABSTRACT

A non-intrusive debugging framework for parallel software based on a super multi-core framework is composed of a plurality of core clusters. Each of the core clusters includes a plurality of core processors and a debug node. Each of the core processors includes a DCP. The DCPs and the debug node are interconnected via at least one channel to constitute a communication network inside each of the core clusters. The core clusters are interconnected via a ring network. In this way, the memory inside each of the debug nodes constitutes a non-uniform debug memory space for debugging without affecting execution of the parallel program, such that it is applicable to current diversified dynamic debugging methods under the super multi-core system.

### BACKGROUND OF THE INVENTION

1. Field of the Invention

The present invention relates generally to a debugging technique of computer software, and more particularly, to a non-intrusive debugging framework for parallel software based on a multi-core environment.

2. Description of the Related Art

In the conventional single-core debugging environment, there are two debugging approaches—hardware and software. Debugging by means of additional hardware, like in-circuit emulator (ICE), is also called remote debugging; namely, the target to be debugged is not at the local site. This hardware-based debugging is to connect the local host to the ICE via the general input/output (GPIO), universal serial bus (USB), and Ethernet channel then transmitting the debugging command toward the internal debugging control unit of the central processing unit (CPU) of the default target through a joint test action group (JTAG). When the CPU debugging controller receives the debugging command, it can command the CPU to stop operation and allow the ICE to dominate the CPU in such a way that a user can debug the CPU for single-step execution and checking the register and memory. In addition to the debugging command, the CPU can also deploy the scan chain internally for the purpose of providing a simple way of setting and observing the register therein to allow the remote debugging user to know the current CPU operating status. It is needed for this hardware-based debugging to add a signal wire of scan enable into the CPU, and when the voltage of the signal wire is heightened, the value of every flip-flop in the register is saved in a shift register file connected in series. The scan chain is meant to test whether or not the flip-flop functions normally; however, such function is taken by the debugger, such that all of current low-cost remote debuggers support such debugging to access the register file. Although such debugging is low-cost, it is slow because accessing one bit usually needs one clock cycle and if it is intended to access a register file having 32 32-bit CPUs, it will need 1024 (32×32) clock cycles.

The debugging by means of software is also called intrusive debugging. The most popular debugger, such as GNU debugger (GDB), is mostly software-based for debugging, allowing a particular software interrupt instruction to replace the memory location of the program counter (PC) designated as the user inserts the breakpoints. When the CPU executes this PC, it automatically executes a debugging service program corresponding to the software interrupt instruction. This software-based debugging includes the advantages of providing more flexible and more breakpoint supports than the hardware-based one and needing no extra hardware support. However, such debugging is intrusive and may result in probe effect according to Heisenberg's Uncertainty Principle; namely, while the target is measured by means of a probe, the probe itself may affect the measuring result. In the software-based debugging, such memory replacement is so-called software probe and may not only affect the sequential consistency of the program execution to result in inconsistent results of sequential executions of two debugging programs, but even make some race conditions disappear or appear, such that unreliable debugging result may happen. In this way, the debugging efficiency of the program developer may be affected and such problem may become more and more serious in the multi-core environment.

Broadly speaking, the parallel software indicates a software executed with more than one thread or process to enhance performance or capacity. Thus, the parallelism generated as the program is executed under the multi-core environment is different from the concurrent generated as it is executed under the single-core environment by means of context switch. “Parallelism” indicates that a lot of incidents are executed simultaneously; however, “concurrent” indicates that only one incident is actually executed at the same time point. Regardless of parallelism or concurrent, the race condition will happen due to programming carelessness. Because the parallel program is much more complex than the concurrent one, how to detect the race condition in the prior art is mostly done under the concurrent environment. Among the algorithms, the eraser algorithm is the most popular one for detecting the race condition, recording the access log of the memory address by the shadow memory and the software probe and recording the lock set of every memory address to be observed, for dynamic detection of the race condition according to defined conditions of the race condition. Most of the utility software programs for detecting the race condition are based on the Eraser algorithm. However, this algorithm may still cause the probe effect and great performance drop. Another method of detecting the race condition is analyzing the traces after the program is executed; however, this method must wait for accomplishment of execution of the whole program. For the software in need of long-time operation, like operation system, will need much storage space beyond common sense for storing those traces.

### SUMMARY OF THE INVENTION

The primary objective of the present invention is to provide a non-intrusive debugging framework, which does not affect the sequential consistency of the program execution in the process of debugging and can improve the unnecessary probe effect and serious influence on the performance in dynamic debugging to enhance the user's debugging efficiency on the multi-core chip.

The secondary objective of the present invention is to provide a non-intrusive debugging framework, which can detect the race condition and improve the need for a lot of shadow memory in debugging.

The foregoing objectives of the present invention are attained by the non-intrusive debugging framework is composed of core clusters. Each of the core clusters includes a plurality of cores and a debug node. Each of the core processors includes a debug co-processor (DCP). The DCPs and the debug node are interconnected via at least one channel to constitute a communication network inside each of the core clusters. The core clusters are interconnected via an independent ring interconnection.

### BRIEF DESCRIPTION OF THE DRAWINGS

FIG. 1 is a block diagram of a preferred embodiment of the present invention.

FIG. 2 is a block diagram of the structure of a core cluster in accordance with the preferred embodiment of the present invention.

FIG. 3 is a block diagram of the internal structure of a debug node in accordance with the preferred embodiment of the present invention.

FIG. 4 is a block diagram of the preferred embodiment of the present invention, illustrating that the checking status inside the debug node while the detection of the race condition proceeds in the target program.

FIG. 5 is another block diagram of the preferred embodiment of the present invention, illustrating that the indexing cache memory corresponds to the inconsistent debug memory.

### DETAILED DESCRIPTION OF PREFERRED EMBODIMENTS

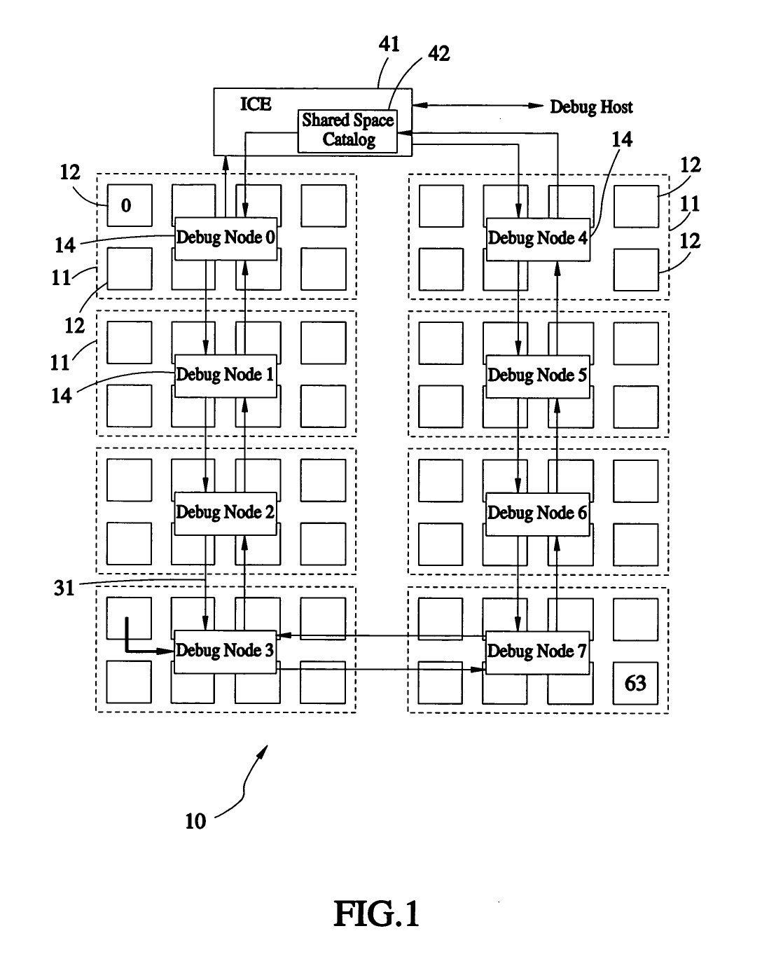

Referring to FIGS. 1-3, a non-intrusive debugging framework for parallel software based on a multi-core framework in accordance with a preferred embodiment of the present invention is composed of a plurality of core clusters interconnected by a ring interconnection 31. The detailed descriptions and operations of these elements as well as their interrelations are recited in the respective paragraphs as follows.

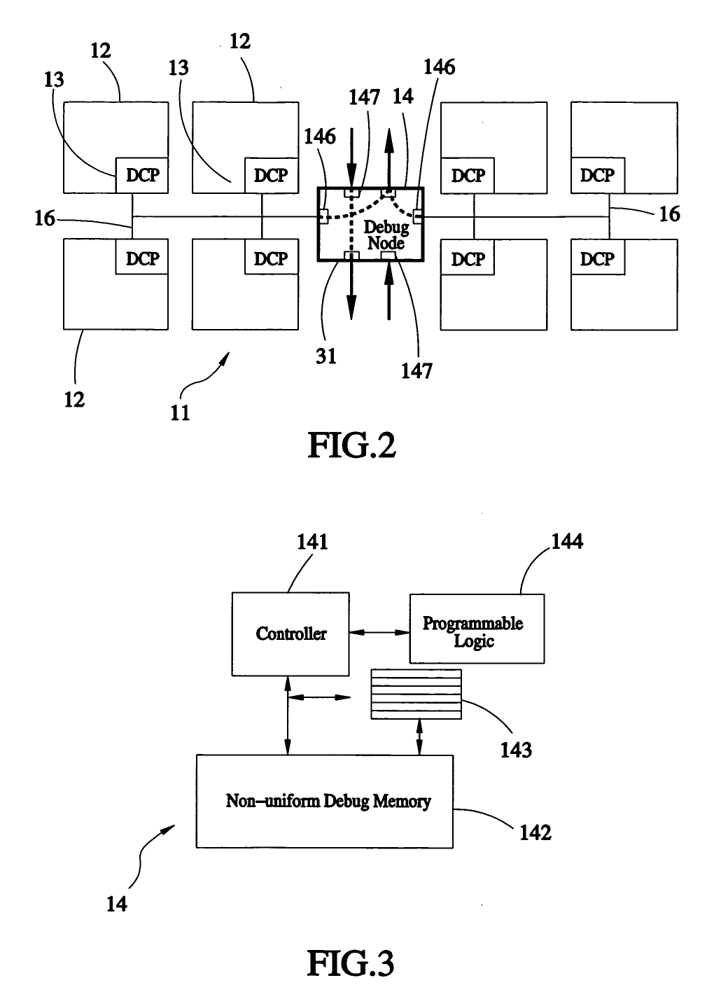

As shown in FIGS. 1-2, each of the core clusters 11 includes two to eight core processors 12 and a debug node 14 connected with the core processors 12 via two debug channels 16, i.e. each of the debug channels 16 coordinate with one to four of the core processors 12. Each of the core processors 12 has a built-in debug co-processor (DCP) 13. Each of the DCPs 13 can support an existing JTAG debug control and be provided for increasing commands and actions of every core processor 12. The core clusters 11 can coordinate with an existing ICE 41 via the ring network 31. The shared spaces dictionary is stored in the ICE 41 for recording the relationship between shared address spaces and the physical memory in each debug node.

Referring to FIGS. 2-3, each of the debug nodes 14 includes a controller 141, a non-uniform debug memory 142, an indexical cache memory 143, a programmable logic 144, a debug connection port 146, and a network connection port 147. The indexical cache memory 143 can not only provide quick data index function for the non-uniform debug memory 142 but become a significant element of the non-uniform debug memory 142. The debug connection port 146 of every debug node 14 is connected with the debug channels 16 for dealing with a lot of information flooding therein. The network connection port 147 is connected with the ring network 31 for providing connection among the other debug nodes 14. Each of the debug nodes 14 can transmit information to another debug node 14 via the network connection port 147 and either send synchronization-token debug commands by broadcasting to transmit the information to all of the debug nodes 14 or transmit debug commands or information by peer-to-peer. The index cache memory 143 is structurally a content addressable memory (CAM) for storing the index address of the local non-uniform debug memory.

The aforesaid shared space catalog 42 is treated as a location saving data for indexing of the corresponding non-uniform debug memory 142.

The controller 141 in each of the debug nodes 14 is provided for controlling access to the index cache memory 143 and the non-uniform debug memory 142 to set the programmable logic 144, to transmit the information on the ring network 31, and to control the action of each of the core processors 12 inside the local core cluster 11. When no space is available in one of the index cache memory 143 and the non-uniform debug memory 142, the controller 141 can seek for the other, which still has space, for storage and for updating the shared space catalog 42. Besides, the controller 141 saves and provides the recorded information in the non-uniform debug memory 142 for the programmable logics 144 of the local and other remote debug nodes 14. The controller 141 can receive a profile of the programmable logic 144 (e.g. while the debugging proceeds, the ICE 41 is used to provide the profile of the programmable logic 144) from outside via the ring network 31, and accordingly set the local programmable logic 144. Further, the controller 141 can forward the information transmitted from the core processors 12 to the programmable logic 144 to identify whether to activate any debug incident according to the content of the non-uniform debug memory 142.

In this embodiment, increasing/decreasing the number of the core clusters 11 and the number of the core processors 12 inside each of the core clusters 11 to reach high resilience to meet the debug requirement under the multi-core environment.

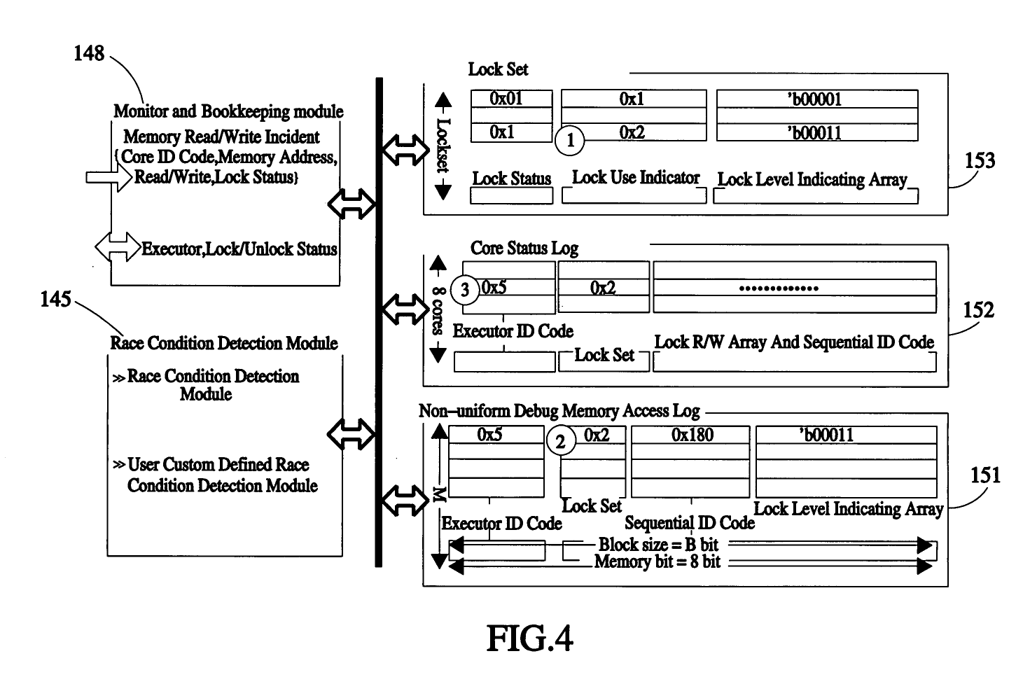

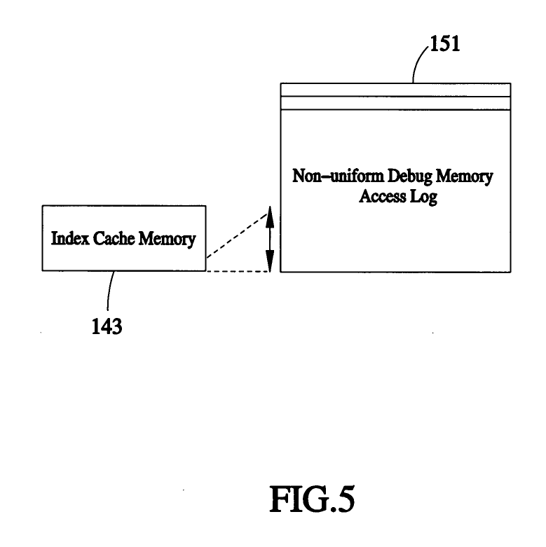

Referring to FIG. 4, each of the debug nodes 14 is installed with a monitoring and bookkeeping module 148. Each of the programmable logics 144 is installed with a race detection module 145. Each of the DCPs 13 can coordinate with a plurality of debug incident commands to provide each of the debug nodes 14 with relevant information, such as lock incident, unlock incident, and context switch incident. Insert the debug incident commands into relevant functions of a thread library (not shown), like lock/unlock function and context switch function. Once the target program executes these special commands, the DCPs 13 will send the relevant debug incidents through the debug channels 16 to the debug nodes 14 and then the monitoring and bookkeeping module 148 of each debug mode 14 can receive and record the incidents and process the different incidents. For example, a memory access incident only needs to be transmitted to a corresponding log; however, a thread or a lock/unlock action has to return a global tag to a corresponding DCP for recordation to facilitate quicker check as the next identical incident is activated.

Referring to FIG. 4 again, the race detection module 145 is based on the Eraser algorithm for detection of the race condition and saving it into the non-uniform debug memory 142 of each debug node 14 with three kinds of logs—(1) shared memory access log 151; (2) core status log 152; and (3) lock set log 153. These three logs can be used for recording the relevant information. The non-uniform debug memory 142 of one debug node 14 shares the three logs with those of the other debug nodes 14, as shown in FIG. 5. The index cache memory 143 corresponds to the shared memory access log 151.

When each of the core clusters 11 runs out of memory or needs to access the information in another core cluster, the aforesaid non-uniform debug memory 142 can be used for quick reference to the required information, thus avoiding the need for a lot of memory. Besides, the present invention can carry out migration to move or duplicate the frequently used data to the inconsistent memory 142 close to the target core cluster 11, thus effectively shortening the time for searching and accessing the data.

In conclusion, the present invention includes the following advantages and effects.

1. The debug framework of the present invention is independent from the multi-core system, such that it is a non-intrusive debug framework and can definitely get hold of the error of the parallel software and debug without affecting program execution sequence, thus being applicable to the race condition.

2. The “non-uniform” memory space, i.e. the non-uniform debug memory, can efficiently share history logs of the program flow and data access to solve the problem of needing a great amount of memory and of synchronization of debug data.

Although the present invention has been described with respect to a specific preferred embodiment thereof, it is in no way limited to the specifics of the illustrated structures but changes and modifications may be made within the scope of the appended claims.

What is claimed is:

1. A non-intrusive debugging framework for parallel software based on a many core multi-core framework, comprising a plurality of core clusters and a debug node, wherein each of the cores in a cluster has a plurality of debug co-processors (DCP), the DCPs and the debug node are interconnected by at least one debug channel to form a communication network inside each of the core clusters, and the core clusters are interconnected by an ring network.

2. The non-intrusive debugging framework as defined in claim 1, wherein each of the core clusters comprises 2-8 core processors.

3. The non-intrusive debugging framework as defined in claim 1, wherein the DCP is built in each of the core processors.

4. The non-intrusive debugging framework as defined in claim 1, wherein each of the debug nodes comprises a controller, a non-uniform debug memory, an index cache memory, a programmable logic, a debug connection port, and a network connection port, the index cache memory being provided for providing index function, the debug connection port being connected with the at least one debug channel for a great amount of data to pass through from the cores, the network connection port being connected with the ring network for providing access to the other debug nodes.

5. The non-intrusive debugging framework as defined in claim 4, wherein the controller of each debug node can control access to the index cache memory and the non-uniform debug memory, set the programmable logic, transmit the information on the annular network, and control action of each core processor inside the core cluster.

6. The non-intrusive debugging framework as defined in claim 5, wherein each of debug nodes is further connected with a shared space catalog; when no space is available in one of the index cache memory and the non-uniform debug memory of one of the aforesaid debug nodes, the controller can seek for another non-uniform debug memory, which still has space, in the other debug nodes for storage and for updating the shared space catalog.

7. The non-intrusive debugging framework as defined in claim 6, wherein the shared space catalog is saved in an in-circuit emulator (ICE) connected with the ring network.

8. The non-intrusive debugging framework as defined in claim 4, wherein the controller of each debug node can save the recorded information into the non-uniform debug memory by dynamic control to provide it for the programmable logics of the local and other remote debug nodes.

9. The non-intrusive debugging framework as defined in claim 4, wherein the index cache memory of each debug node can be a content addressable memory (CAM) for saving index address of the local non-uniform debug memory.

10. The non-intrusive debugging framework as defined in claim 4, wherein the controller of each debug node can receive the profile of the programmable logic via the ring network from outside and set the programmable logic; the controller of each debug node can forward the information received from each of the core processors to the programmable logics to identify whether to activate any debug incident according to the recorded content in the non-uniform debug memory.
